(19) United States
(12) Patent Application Publication
(10) Pub. No.: US 2006/0260752 A1
(43) Pub. Date: Nov. 23, 2006

(54) System and method for producing small production runs of products having removable coatings

(75) Inventor: Jesse D. Crum, Fort Scott, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/292,446

(22) Filed: Dec. 2, 2005

Related U.S. Application Data
(63) Continuation-in-part of application No. 11/135,481, filed on May 23, 2005.
(63) Continuation-in-part of application No. 11/135,179, filed on May 23, 2005.
(63) Continuation-in-part of application No. 11/135,131, filed on May 23, 2005.
(63) Continuation-in-part of application No. 11/151,571, filed on Jun. 13, 2005.
(63) Continuation-in-part of application No. 11/166,858, filed on Jun. 24, 2005.

(51) Int. Cl. B65C 11/02

(52) U.S. Cl. 156/384

(57) ABSTRACT

The present invention relates to a continuous manufacturing method and system for generating short production orders of pressure sensitive products having discretely printed indicia on a number of individual segments. The indicia is provided on at least one face of each of the segments and the printing or imaging is at least partially, temporarily concealed with an opaque, removable coating. The segments are prepared through a unique process that enables a sheet to be printed in a number of predetermined areas through use of a high quality image generating device and then the sheet is severed into individual, discrete segments, with each segment potentially representing a single order, portion of an order or production of a customer requirement. The segments may each be provided with additional removable elements such as removable piggyback labels, dry release cards and the like.

### CROSS-REFERENCES TO RELATED APPLICATIONS

This application is a continuation-in-part of application Ser. No. 11/135,481 filed May 23, 2005, Ser. No. 11/135,179 filed May 23, 2005; Ser. No. 11/135,131 filed May 23, 2005; Ser. No. 11/151,571 filed Jun. 13, 2005 and Ser. No. 11/166,858 filed Jun. 24, 2005 the disclosures of each of which including that found in the claims is incorporated herein by reference.

### FIELD OF THE INVENTION

The present application is directed toward the production of short run products, including laminates, pressure sensitive adhesive assemblies and other business communication products that are produced in small, personalized batches for selective or specialty applications. More particularly, the present invention pertains to a system and method for generating individualized information handling products through a highly automated and continuous process that provides an end user with a product offering that readily services niche markets and other one time use items. The product produced by the system of the present invention may be further provided with removable coatings so that indicia, that has been imaged using a high quality imaging device is temporarily concealed by a substantially opaque coating until revealed at a later time by a recipient, such as by using abrasive action, in order to disclose the underlying printing.

The business communication products produced in accordance with the present invention are manufactured in a unique manner which includes the pre-printing of large sheets that are then cut down to individual segments or ribbons. Each segment or ribbon may represent a discrete, individual preprinted area corresponding to a specific order on the sheet. The ribbons or segments can be used for a number of printed communication pieces such as labels, tags, cards, etc.

The segments, after printing, are then converted to or merged with a continuously advancing web to create a continuous intermediate roll format product that is created by placing the individual segments on the web in a sequential fashion. The segments that have been affixed to the web may then have a temporary, removable over coating applied on either the entire upper face of the segment or alternatively only to selected areas of the segments.

### BACKGROUND OF THE INVENTION

There are a plethora of office products, business forms and stationery items available in the market today and yet with this inordinately large selection of offerings and permutations, there remains a continuing need to develop new products due to changes in technology, societal trends, diversification and new information handling needs of businesses and consumers alike.

However, while printed products, such as pieces that are intended to be used in business communications, can be delivered in a wide variety of formats, constructions and configurations, manufacturing of such diversified products may be unattainable by most producers of such products, particularly smaller sized manufacturers. Normally, one of the most significant limiting factors for a manufacturer in being able to produce a particular construction or expand product capabilities is the equipment the manufacturer has on hand to generate such printed pieces. Such forms handling machinery can be quite expensive and in addition the equipment may require some customization before the equipment can be integrated into a particular manufacturing processes.

In addition to equipment limitations, customers for such business communication products may also be limited by production capabilities. That is, traditional manufacturers of business communications may not accept an order based on size of the job, or more particularly the order quantity or value of the order. The rationale behind such decisions is often primarily due to cost factors which may result in a customer not placing an order with a manufacturer for a small to medium sized piece quantity as the set up or make ready of the job makes the order cost prohibitive, even assuming that the manufacturer would accept the order if a particular price could be obtained to justify production.

Such conventional manufacturers have normally produced product runs that range in the hundreds of thousands to millions or even tens of millions of pieces for a single order. As such, the equipment that is used to produce this level or quantity of product is then set up to handle only large manufacturing runs. The apparatus used in this type of fulfillment will normally only operate efficiently in this higher range of production quantities and often cannot be reconfigured. Thus, even if a manufacturer wished to pursue smaller runs or orders sizes, the manufacturer is faced with the dilemma of making new capital expenditures to purchase equipment that specializes in this type of application not to mention having to retrain existing personnel or hire and train new employees to generate this type of production activity.

Another drawback facing conventional manufacturers of business communication products is that in addition to the possibility of retooling the production infrastructure, the producers may also need to seek out new sales channels and distributors for products that fall within the smaller production run niche as the conventional sales channels are likely still focusing on procuring orders for larger production runs.

A still further drawback of trying to migrate to smaller customer applications relates to quality of the pieces that need to be generated. With the focus of the market slowly shifting to smaller runs, the end user is now demanding a greater image quality than that typically associated with conventionally printed products. It is believed that the reason for such far reaching changes is that budgets for marketing and business communications have been cut back in recent years and as such, end users want more from each individual piece that is produced rather than relying on the quantity of pieces or bulk mailing to generate the desired result.

Flexography is one exemplary conventional technology that is commonly used today for the printing of decorative items, because of the ability to print multiple colors. Flexographic technology is commonly used in the rendering of packaging, marketing communications and normally will utilize a series of plates and one or more stations, containing inks; to apply colored images to the web as the web traverses the press. Through improvements in ink qualities and other modifications and enhancements in the technology, the image quality in flexographic presses and resulting products has improved to about 150 lines per inch.

Typically, for a point of reference, screens that have rulings of about 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms in cooperation with electronic scanners and image setters to produce halftone images that are to be subsequently used to render an image. The pixels of digitized images are first assembled into dots that are then used to form shapes, sizes, rulings, etc. which create the ultimate image produced on the substrate.

While flexographic technology or flexography is desirable for use in such printing due to the economies that can be achieved when compared with other types of printing processes, such as lithography, there are a number of drawbacks in utilizing this process for certain applications. Initially, the quality that a press can produce is often limited, despite improvements in the technology to about 150 lines per inch. This can make some complicated graphics appear “grainy”. Other images such as those that use flesh tones or deep or rich colors, may look faded or “washed out”. The effects of this level of image resolution can detract from the product appearance which may diminish the value of the technology and the products produced particularly for the high end pressure sensitive market. With increasing sophistication of consumers, as well as technology and expectations from each, such effects may be undesirable to potential end users.

Use of such conventional manufacturing technology also suffers from other drawbacks, such as the time that is involved in preparing a production job to run or “make ready” as it may otherwise be known in the industry. That is, the steps that are used to prepare the manufacturing equipment for running a particular job or order. This “make ready” process includes such activity as the preparation of multiple plates to produce the image at each station, mixing inks, calibration and alignment of the images between stations and the like.

Operation of such conventional manufacturing presses may also include multiple operators which can add to production costs. In addition, waste can also be a problem with such conventional printing technologies in that a number of feet, yards or meters of web material must be processed through the press in order to have the colors reach a predetermined threshold and to ensure appropriate registry of the stations as they are printing the images on the web. The amount of material wasted can be several times the length of the press or up to several hundred feet of material. The use of such volumes of materials obviously increases the cost of the operation. Thus, due to the make ready process and waste factors, the production of high end pressure sensitive products through the use of such conventional manufacturing equipment may then be limited to serving only certain market segments, namely large market segments.

Markets that are applicable for this technology segment are generally believed to be those orders for large quantities of hundreds of thousands or millions of pieces, which potentially leaves the smaller label market, e.g. 100 to under a 1,000,000 labels, unfulfilled or at least not adequately served by currently available technologies due to cost and materials thresholds.

What is needed, therefore, is a production method and system by which high quality graphics can be used to create products for a number of distinct, individual printing orders or applications for a batch of individual, separate orders in a single continuous process. For example, the system described in the present invention can create an order that may be produced with graphics having a resolution in excess of about 150 lines per inch. The system and method of the present invention can produce products in an efficient and cost effective manner, such as in a continuous system operating at greater than fifty feet per minute. Moreover, such a system would greatly expand the penetration of high quality business communications available in the marketplace by placing the pieces in the hands of the small to medium sized user.

The present invention seeks to provide a system for producing an intermediate web assembly that is capable of having a number of different discrete segments, representing a number of individual orders and composed of multiple pieces, e.g. labels, cards, tags, plastics, films and the like. The products produced using the present system enables the manufacture of such business communication pieces in an efficient and cost effective manner. The segments that are prepared from a pre-printed sheet will typically consist of a series of discrete individual elements with each element or segment having printing or imaging that includes graphical or resolution quality of about 150 or more lines per inch and preferably more than 300 lines per inch, which is approximately equal to about 2500 to 3500 dots per inch (“DPI”) in order to create a high quality imaged product that is intended to be aesthetically appealing to the consumer and to more effectively communicate the business message of the application in the small to medium range market applications. The system may be further used to apply temporary, removable coatings to a least a portion of the surface of the segment so as to be able to provide an offering that serves the needs of specialty market applications. In addition, the system can be used to create unique overlays, such as piggyback pressure sensitive configurations.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention relates to an automated system and manufacturing method for producing a range of business communication products including pressure sensitive assemblies, laminates and signal ply materials. The system and method prepares a series of discrete ribbon segments from sheets of printable material that are imaged in a number of pre-determined areas. Each of the areas may relate to individual orders and the areas are then severed from the sheet to produce separate ribbons or segments that are placed on a carrier web. At least a portion of the printed area on each of the segments is then coated with an opaque material so as to temporarily conceal at least a portion of the printing until the coating is removed, such as by abrasive action.

In one exemplary embodiment of the present invention, a system for producing individual personalized business communication products in a continuous fashion, is provided and includes an order entry system that is used for calculating parameters for at least one order. The parameters are obtained from a first data set with the first data set including information on at least size and shape configurations available for use with the order. The order entry system further includes an order placement component to determine placement of each order on a sheet of printable material.

A series of segments are obtained from the sheet with each of the segments having a predetermined configuration provided in accordance with the order. An image generating device is used for producing indicia on each of the segments with each segment relating to the at least one order and the indicia having a resolution greater than about 150 lines per inch.

The system of the presently described embodiment further includes a web handing device that is used for moving a carrier web in a machine direction. A coating system is used to apply at least an over coating of material to temporarily conceal at least a portion of the indicia produced by the image generating device on each of the segments. A placer mechanism is provided and used for positioning each of the segments relating to the at least one order on the carrier web in a sequential order on the web to create a continuous web having a number of removable labels.

The system of the present invention may also use an adhesive coating and silicone release coating station in the event that pressure sensitive products are being created as part of the business communication. In addition, a die cutting unit, preferably a laser die cutting station may also be provided to cut each of the segments into previously specified shapes as part of the order.

In a yet still further embodiment of the present invention, a system for producing a number of discretely printed segments with a removable opaque coating in small quantities or batches, is provided and includes an order entry system for capturing specific details relating to production of a particular order for a business communication piece. The system also includes a print generation device that is used for printing sheets in discrete areas and for generating graphics and imaging at greater than about 150 lines per inch.

At least first and second segments are cut from the printing sheets with each of the segments having first and second faces and with indicia printed on at least one of the first and second faces of each of the first and second segments. The indicia on the first segment are distinct from the indicia on the second segment. The printing on the first segment as well as its configuration relates to a first order and the printing on the second segment relates to a second order distinct from the first order.

In addition, the presently described system includes a carrier web handling device that is used for transporting a carrier web in a machine direction and for receiving each of the at least first and second segments in a sequential fashion. An opaque coating station is provided for applying an opaque coating to a portion of the indicia printed on one of the first and second faces of each of the segments to temporarily conceal at least a portion of the indicia.

In a still further embodiment of the presently described invention, a system for creating personalized pieces having opaque coatings in small quantities or batches is presented and includes a number of pre-printed ribbons, with each ribbon containing distinct printed indicia on at least one face. The pre-printed ribbons representing at least two distinct printing orders that were entered at the substantially similar time.

The presently described embodiment includes a carrier web that is used for receiving each of the pre-printed ribbons and for moving each of the ribbons in a machine direction. The web may be a release coated web or other web that is suitable for receiving and advancing the ribbons.

A coating station, which will typically be positioned downstream from where the web receives the ribbons in one embodiment, is used for applying an opaque coating over at least a portion of the indicia on each of the ribbons to temporarily conceal at least a portion of the indicia from view. Alternatively, the coating station can be used prior to coat each of the ribbons prior to placing the ribbons on the carrier web. The system also includes a verification assembly that is used for confirming the coating of the portion of the indicia.

In connection with the foregoing embodiments, the indicia may be printed in two portions, with one portion containing printing provided in a static or fixed format and the other portion containing printing that is personalized or variable. Preferably, the coating will be applied over the personalized or variably printed indicia so that when the recipient removes the opaque coating a unique message, will be displayed to the recipient.

The system described in the present invention may be used to create a continuous product configuration, such as a roll or fan folded product, or a series of sheets with each sheet containing at least one removable label with a removable coating provided over printed indicia.

The system may also be used to provide pre-printed segments that have removable overlays, so that unique carrier webs can be created with both modified and unmodified segments, e.g. with and without a piggyback assembly.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a schematic of the order entry system used in connection with the present invention including an image generation device and printed sheet;

FIG. 1A shows a schematic of the processing system used in connection with the order entry system of FIG. 1;

FIG. 2 illustrates a front view of a product produced in accordance with the present invention showing a partially concealed variably printed portion; and

FIG. 3 provides a side elevation view of a product produced in accordance with the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

Unexpectedly, it has been discovered that small production orders for personalized printed products having removable opaque coatings can be produced by using the present system and method described in the instant invention. The opaque coatings temporarily conceal a layer of printed indicia which may be removed by end users or consumers of the product. The products produced in accordance with the present system can be produced in a continuous format, e.g. roll or fan folded, sheeted arrangement, piggy back configuration, or with some level of variability.

A multiplicity of individual print production orders can be entered through an efficient order entry system which will determine placement and size configurations for each of the orders that have been received. The system will determine placement of each of the orders on a sheet of printable material such as one having a synthetic film or cellulosic base and then will print each order on the sheet. The sheet is then separated into a number of discrete segments or ribbons with each ribbon potentially relating to an individual order. It however should be understood that the multiple ribbons may make up portions of a single order. Each segment or ribbon can then be printed in multiple portions with one portion potentially provided fixed or static indicia and another portion providing personalized or variable indicia. Then, preferably the variable or personalized indicia is coated with an opaque material that is subsequently removable.

As used herein an “order” or a “production order” refers to an order for a single product type, selected for example from a group including labels, prime labels, cards, tags, magnetic products, laminated products, printed pieces, scratch and scuff off and the like. Where two or more orders are produced in a single production run, the orders may come from a single entity or from multiple discrete entities, that is, one customer or multiple customers.

For example, a restaurant may order scratch or scuff off products for placement on “take-out” food containers and coupons or gift checks for in store promotions. Each item, in this example, represents an order for a particular product, although each of the products originates from the same customer or end user and will be likely paid through a single invoice.

Likewise, two distinct end users or distributors may each place an order for a scratch off product, for each of their respective uses, and each scratch or scuff off product will have distinct indicia or graphics for the application such as different prizes, award codes, messages, coupons, and the like. Thus, there are two distinct orders, two invoices and two customers. In each of these examples, the products or orders can be generated in the same production run as opposed to using conventional manufacturing processes or equipment, where the orders must be run separately from each other. Thus, by using the current process and system, a number of small to medium sized orders can be produced, which heretofore may not have been possible due to quantity restrictions.

It should be understood, that the invention is not limited to two types of orders or products, and instead it should be realized that multiple orders, including a multiplicity of products from a variety of end users can be produced simultaneously using the method and system of the present invention.

As used herein the term “business communication” or “information handling document” is used to refer to a printed or imaged piece, document or substrate that, either alone or in combination with other documents can convey a particular message, image or provide information about a particular product or service that is available from the provider of such pieces or documents. Business communication or information handling documents or pieces can include advertising, sales and marketing collateral and such other items used to convey information on written or imaged form sheets, brochures, presentation folders, informational sheets and combinations thereof.

The term “personalized or variable information” refers to information that is printed or imaged onto a substrate or document which is generally variable or unique and which may change from document to document or segment to segment so as to create a customized message or communication for each recipient. Examples of personalized information may include names, addresses, descriptions, plans, coding, numbering, promotional text, etc. that may have been acquired from the intended recipient through surveys, questionnaires or answers given to various inquiries generated in response to a request for goods or services.

The term “static or fixed” information refers to printed or imaged information that generally does not change from document to document or segment to segment and may include a general description or body of information about particular products, services, places, etc. that may be of interest to the intended recipient and represents a standard message that the manufacturing or supplier wishes to convey to an end user or customer of the offering.

The term “sheets” or “segments” as used herein refers to sheets, segments, ribbons, strips, pieces, parts, sections, subdivisions and combinations thereof. The sheet or segment provided as an example for the purposes of this specification can be an entire sheet such as 8½″×11″, 11″×14″, 19″×25″ and other known sheet sizes or may be segments, divisions, strips, etc. of such sheets. For example, a 19″×25″ sheet may be produced with five rows of labels, with each row having six labels, with each label having dimensions of approximately 3″×4″. For instance, in this example, each row may comprise an individual segment or sheet that may be used in practicing the present invention. It should however be understood that the invention is not to be so limited to the foregoing configuration and that individual pieces or elements, regardless whether the piece or elements have a regular or irregular shape, may be used in connection with this process to produce the intermediate assembly that is described in this application.

As used herein, the term “templates”, “segment”, “ribbon” or “element” refers to a particular size, configuration or arrangement of a piece. For example, the template or segment may have a size of 3″×5″, 2″×4″, 1″×2″ and other sizes that may be customarily produced. The term templates can be used to refer to segments, ribbons and similar terms and are used interchangeably.

Through use of the present invention, a vast array of printed segments can be placed on a web, whether or not coated with adhesive, and then collected for later use, thereby creating a versatile web assembly that can be used to fulfill the production needs of multiple clients without the need of preparing the equipment for separate runs for each order that may have been received. Through the use of the foregoing process a manufacturer may create innumerable high quality graphics, illustrations and variable and personalized text and indicia to create a greater impact on the potential consumer or end user. The foregoing process has a number of benefits over conventional technologies in that the process can occur at roughly equivalent press speeds and may be handled by conventional applicators.

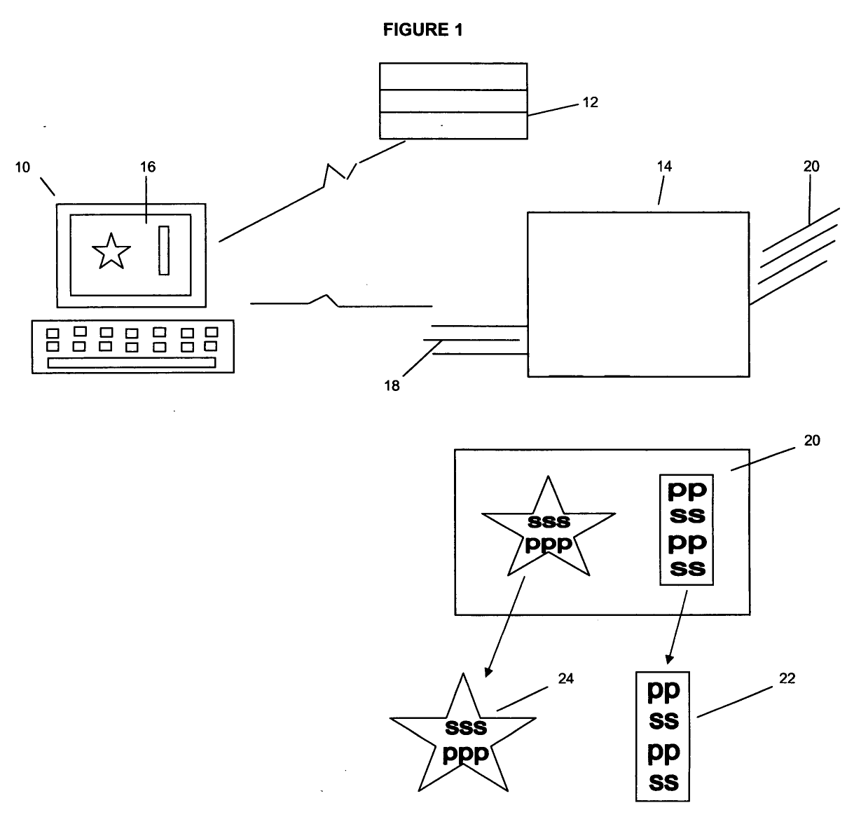

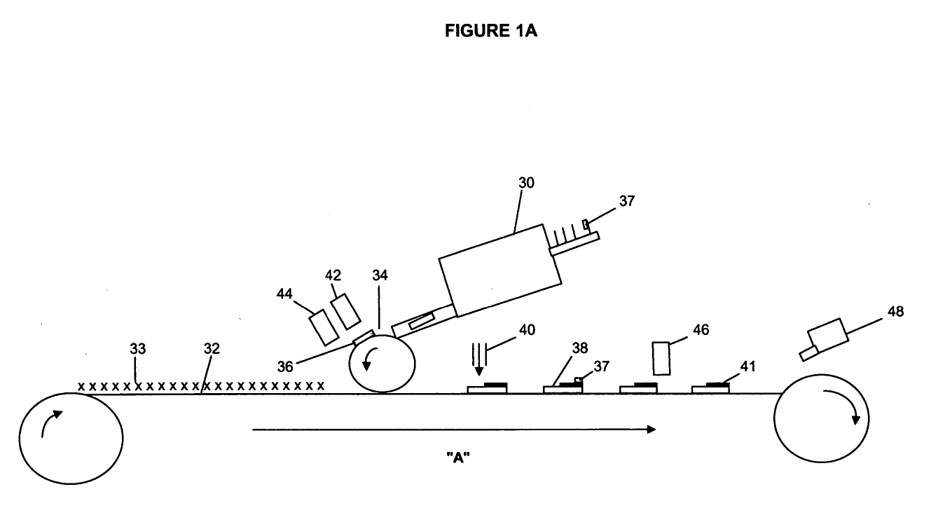

Reference is now directed at FIG. 1 of the present invention which shows a schematic of the order entry system 10 connected to a first data set 12 and a high image resolution device 14.

Examples of high quality image generating devices that are suitable for use in practicing the invention include high resolution imaging devices such as Indigo®, available from Hewlett Packard of Palo Alto, Calif. or Karat available from KBA of Williston, Vt. Ideally, the present invention seeks to provide a segment or intermediate with a series of segments that has a quality of about 150 or more lines per inch and preferably more than 300 lines per inch, which is approximately equal to about 2500 to 3500 dots per inch (“DPI”) in order to create a high quality image that is intended to be aesthetically appealing to the consumer.

The order entry system provides sheets 16 in an automated format which draws information from a first data set 12 to determine the layout, size and positioning of each of the segments or ribbons that are to be printed on the sheets. Sheets 18 are placed in a hopper for the imaging device 14 and after printing the sheets 20 are then cut into discrete segments 22 and 24, with each segment relating to at least one order. Cutting of the sheet may be accomplished by die cutting, laser die cutting, guillotine or other suitable means known in the industry.

Each of the orders that are preferably manufactured in connection with the present invention is intended to be in quantities below predetermined thresholds. That is, orders ranging from one piece to several hundreds or possibly thousands. However, the system is primarily geared for smaller production runs and preferably will generate orders ranging from one to about one thousand and more preferably from one to about one hundred.

The segments are preferably printed with static printing, here represented by the letter indicia “S” and personalized indicia, here represented by letter indicia “P”. The printing occurs in two distinct areas of the segment so that the static portion will preferably occur in a first portion and the personalized printing in a second portion.

Turning now to FIG. 1A, each of the segments is then placed into a hopper for a feeder mechanism 30 that will be used to individually place the segments on a web 32. An exemplary feeder or placer mechanism is available from Maverick® available from In-Line Automation of Minneapolis, Minn. The exemplary unit may use a vacuum cylinder 34 to take the segments from the hopper and then deposit the individual segments 36 sequentially on the surface of the web 32 to create incremental segments 38 that are positioned over an adhesive in a machine direction designated by “A.” It should be understood, that the invention is not limited by the type of placer mechanism used in the present example. Certain segments 37 may be provided with removable overlays, such as a piggyback portion that can be removed by the recipient. These modified segments 37 may be placed in the hopper of the placer 30 along with other non-modified segments. In this manner, a unique carrier web can be created that has unmodified segments as well as piggyback configured segments.

The web 32, which may have a coating of pressure sensitive adhesive 33 applied to one face thereof, is advanced past the feeder mechanism 30 and then the segments 36 are individually deposited in a sequential fashion onto the web 32 over the pattern of adhesive 33 to create a laminated web assembly that has a series of individual segments that are disposed in a substantially edge-to-edge relationship.

The schematic presented in FIG. 1A may also have a coating head 40 which is used to apply an opaque coating over at least a portion of the segments 38 as shown by reference numeral 41. In addition, the exemplary manufacturing equipment may also be provided with an adhesive coating unit 42 in the event that the web has not been provided with a pattern of adhesive and/or a silicone application unit 44 which can be used to provide a release coating to a surface of the segment.

The exemplary manufacturing apparatus may also be provided with a die cutting station 46 that can be used to produce the final shapes in the segments after they are coated with the opaque coating. The die cutting may be performed over the length of the segment or alternatively only in predetermined areas of the segment. The system may also employ a verification unit 48 to confirm coating of any information that is intended to be concealed from view.

While FIG. 1A provides an illustration of a continuous format for collecting the product that is produced by the system described in the present invention, it should be understood that the product can be produced in a sheet form as well as roll format. Alternatively, the product can be collected in a roll format and then fan folded or then cut and to create a sheeted product. Each sheet or each layer of a fan folded configuration will contain at least one printed segment with a temporary covering concealing the printed indicia.

The placer mechanism of the system of the present invention may also be used to place supplemental pieces on each of the segments such a piggy back labels, dry release tags, and the like. In this arrangement, an alternating configuration of materials are placed in the hopper of the placer, such as a segment then a label, segment, then tag and so on such that random configurations can be produced by using the system of the instant invention. Alternatively, additional placer mechanism can be added to the system in order to place each item on the carrier web.

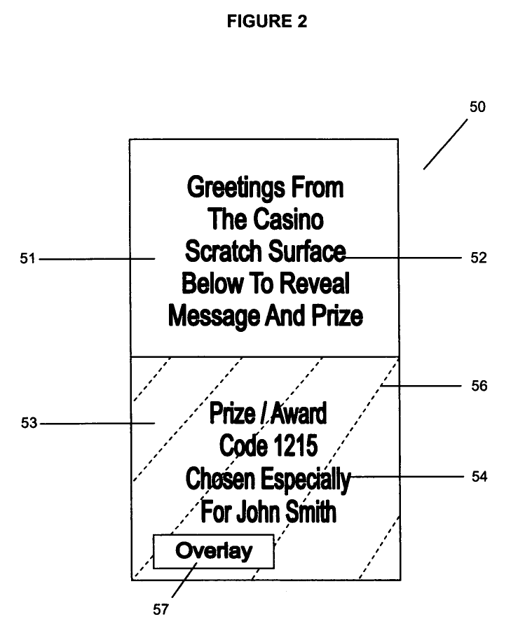

Attention is now directed at FIG. 2 of the present invention which depicts a front view of a product 50 produced in accordance with the present invention. The product 50 includes first and second portions 51 and 53. On the first portion 51 static or fixed printing 52 is provided. The printing will remain constant each time such an order is generated. In the second portion 53 variable or personalized printed 54 is provided relating for example to a particular guest. In this example, each time a guest makes a reservation, the template of the first portion 51 is retrieved from the order entry system and then the guest information is added in the second portion 53. An opaque coating 56, here represented by phantom lines is then provided over the top of the variable printing 54 so as to conceal the printing from view of the guest. The guest would then scratch or scuff off the coating to reveal the underlying personalized message.

FIG. 2 also shows a removable overlay assembly 57 that can be provided over the temporary opaque coating so as to create an additional communication piece for the manufacturer to convey a particular promotional message to the recipient of the marketing piece.

The foregoing process may also undergo additional steps such as sorting of the segments by individual job order. That is, when the segments are cut from the sheet all of the segments relating to a specific job are collected and then placed into the hopper or feeder mechanism so that they can appear on the web one after another. In this manner, the segments relating to a job can all be placed together on a section of the web so that, the respective section(s) may then be cut and delivered to the end user. Alternatively, the sorting may occur after the segments have been placed onto the web and the individual segments are then collected when the web in its intermediate laminated form is cut or severed.

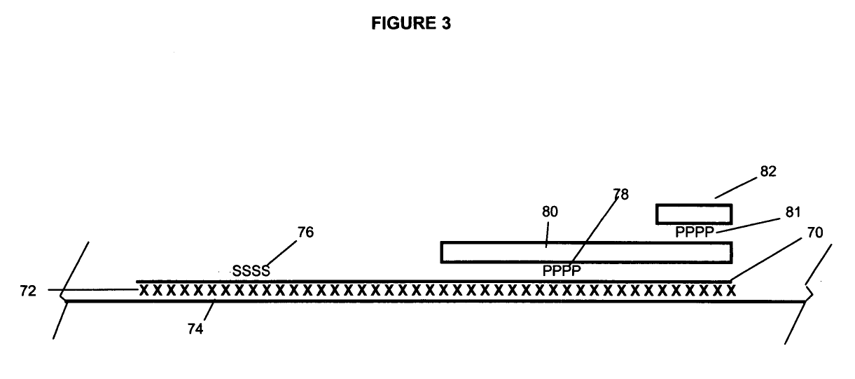

FIG. 3 provides a side elevation view of an exemplary product produced in accordance with the present invention. The segment 70 in this embodiment has been provided with a pattern of adhesive 72 which is covered by a release liner 74, such as one that might have been provided through use of the carrier web. The segment is provided with static printing 76, represented by “S” in the FIG. and personalized printing 78, represented by “P” in the FIGURE. Over the personalized printing 78 is provided an opaque layer 80 which is used to conceal the personalized printing 78 from view. The coating is used to temporarily conceal the personalized printing and may be removed to reveal the message such as by using abrasive or rubbing action. It should be understood that while the coating has been provided only over a portion of the segment, the coating may be applied over the entire length of the segment to conceal all the printing, regardless of whether the printing is personalized or static.

FIG. 3 also shows a further modified embodiment of the product produced in accordance with the present system. A further overlay or piggyback element 82 is supplied over the coating 80. The piggyback 82 overlay may conceal additional printing “PPP” 81 allowing the issuer of the product to provide additional messages to the recipient.

By providing products in this piggyback configuration, the individual segments 70 may be removed from the carrier web 74 and the segment 70 attached to an object, package, container, etc. Then the recipient of the package can remove the piggyback overlay revealing a first message and still then remove the temporary coating 80 to reveal a second message, thereby further expressing the manufacturer's promotional messge.

It should also be recognized that while a pressure sensitive construction has been presented, the segment may also be obtained from a single ply of material or other laminated configuration. The exact make up of the construction will be determined by the requirements of the end user.

Practice of the present system and method enables the production of individual or small quantities of variably imaged scratch or scuff off type products that can be used in various promotional, marketing or advertising arrangements.

It will thus be seen according to the present invention a highly advantageous system and method for producing individual pressure sensitive adhesive based products in a continuous fashion has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A system for producing small quantities of individual, personalized business communication products in a continuous fashion, comprising;
an order entry system for calculating parameters for at least first and second orders, each of said orders below a predetermined threshold, said parameters are obtained from a first data set with said first data set including information on at least size and shape configurations available for each of said first and second orders and said order entry system further including an order placement component to determine placement of layouts for each of said first and second orders on a sheet;
a series of segments obtained from a printable sheet of material, each of said segments having a predetermined configuration provided in accordance with a specific order determined from said order entry system;
an image generating device for producing indicia on each of said segments while said segments are on said printable sheet with each segment relating to said at least one order and said indicia having a resolution greater than about 150 lines per inch;
a web handing device for moving a carrier web in a machine direction;
a coating system for applying at least an opaque over coating of material to temporarily conceal at least a portion of said indicia produced by said image generating device on each of said segments;
a placer mechanism for positioning each of said segments relating to said at least one order incrementally on said carrier web in a predetermined sequence to create a continuous roll of product having a number of removable labels; and
a verification device for confirming that said opaque coating is covering at least a portion of said indicia.

2. A system as recited in claim 1, wherein said system further includes a laser die cutting unit for producing uniquely shaped segments.

3. A system as recited in claim 1, wherein said system further includes a web take up device for collecting said web with each of said segments applied thereto.

4. A system as recited in claim 1, wherein said system includes a supply of segments for use in providing each segment in a sequential fashion to said placer mechanism.

5. A system as recited in claim 1, wherein said system further includes an automated design platform for creating at least unique shapes, sizes and indicia on each of said segments.

6. A system as recited in claim 1, wherein said system includes placing distinct elements in alternating configurations in a hopper of said placer mechanism to create piggyback pressure sensitive configurations.

7. A system as recited in claim 1, wherein said system further includes an adhesive coating station to apply adhesive to a portion of each of said segments.

8. A system as recited in claim 1, wherein said system further includes a silicone coating station to apply silicone to a portion of each of said segments.

9. A system for producing a number of discretely printed segments in small quantities with a removable opaque coating, comprising;
an order entry system for capturing specific details relating to production of a particular order for a business communication piece with each said order being below a predetermined threshold;
at least first and second orders received from at least one source for printed communication pieces;
at least one sheet of printable material;
a print generation device for printing sheets in discrete areas on said sheet of printable material relating to each of said first and second orders, said print generation device producing graphics and imaging at greater than about 150 lines per inch;
at least first and second segments cut from said printable sheet with each segment having first and second faces and with indicia printed on at least one of said first and second faces of each of said first and second segments and said indicia on said first segment is distinct from said indicia on said second segment, with said first segment relating to a first order and said second segment relating to a second order distinct from said first order;
a carrier web handling device for transporting a carrier web in a machine direction and for receiving each of said at least first and second segments in a sequential fashion; and
an opaque coating station for applying a removable opaque coating to a portion of said indicia printed on one of said first and second faces of each of said segments to temporarily conceal said indicia.

10. A system as recited in claim 9, wherein said system further includes a placer mechanism for individually placing said first and second segments on said carrier web.

11. A system as recited in claim 9, wherein said system further includes a laser die cutting station for cutting each of said first and second segments into distinct shapes.

12. A system as recited in claim 9, wherein said system further includes an adhesive application station for applying adhesive to at least a portion of said first and second segments.

13. A system as recited in claim 9, wherein said carrier web is a release coated web.

14. A system as recited in claim 9, wherein each of said segments are laminated segments.

15. A system as recited in claim 9, wherein each of said segments are constructed of a single ply from a card, tag or board stock.

16. A system for creating personalized pieces having opaque coatings in small batches, comprising;
a number of pre-printed ribbons, with each ribbon containing distinct printed indicia on at least one face, said pre-printed ribbons representing at least two distinct printing orders that were entered at a substantially similar time, and at least one of said pre-printed ribbons having a removable element applied to at least a portion of said ribbon;
a placer mechanism for positioning each of said pre-printed ribbons on a carrier web in a pre-determined order;
said carrier web for receiving each of said pre-printed ribbons and for moving each of said ribbons in a machine direction;
a coating station for applying an opaque coating over at least a portion of said indicia on each of said ribbons to temporarily conceal said portion of indicia; and
a verification assembly for confirming coating of said portion of said indicia which is to be temporarily concealed.

17. A system as recited in claim 16, wherein said printed indicia includes first and second portions.

18. A system as recited in claim 17, wherein said first portion of said printed indicia includes static or fixed printing and said second portion of said printed indicia includes personalized printing.

19. A system as recited in claim 16, wherein said system further includes a placer mechanism for sequentially placing each of said ribbons on said carrier web.

20. A system as recited in claim 16, wherein said system further includes an order entry system connected to a high resolution imaging device for printing discrete images at a resolution greater than about 150 lines per inch.
